(19) United States
(12) Patent Application Publication
(10) Pub. No.: US 2001/0047248 A1
(43) Pub. Date: Nov. 29, 2001

(54) Method and device for correcting aiming errors between devices

(76) Inventors: Peter Toth, Kloten (CH); Essam Badreddin, Adliswil (CH)

Correspondence Address: McCormick, Paulding & Huber, City Place II, 185 Asylum Street, Hartford, CT, 06103-3402, US

(21) Appl. No.: 09/768,425

(22) Filed: Jan. 24, 2001

(30) Foreign Application Priority Data
Apr. 26, 2000 (CH) 2000 0818/00

(51) Int. Cl. G01D 18/00

(52) U.S. Cl. 702/104; 702/94

(57) ABSTRACT

The method is employed for correcting aiming errors between devices of fire control systems and weapons installations by aiming guns (G) with target measuring sensors (Sg) on a common measuring target (K, Kᵢ) by means of a target tracking device (T) in order to detect deviation values (Dᵢ) between the position of the measuring target (Kᵢ) and of the gun (G) controlled by the target tracking device (T), which is represented by the aiming (O) of the target measuring sensor (Sg). Following the evaluation of the position deviation, an aiming error vector (B) is processed for being taken into account in a servo gun control. The correction of the aiming error vector (B) is performed recursively in accordance with the method of the least error squares.

### FIELD OF THE INVENTION

The invention relates to a method for correcting aiming errors between a sensor device and an effector device controlled by the sensor device via a servo device by means of a correction of an aiming error vector (B). The invention also relates to a device for executing this method.

### BACKGROUND OF THE INVENTION

A method for correcting aiming errors between gun carriages and devices arranged thereon is known from EP 0 314 721 B1, wherein the devices can be fire control systems and weapons installations. The method is executed by using device correction values of the rough position of the installed devices, measured with the fire control systems and weapons installations at rest, and by taking them into account in the servo controls of the gun carriages. The correction values for the devices are known at the factory and/or are determined from measured values.

### OBJECT AND SUMMARY OF THE INVENTION

It is the object of the present invention to improve such a method and to propose a device for executing it.

This object is attained by the invention in an advantageous manner by means of a method in accordance with claim 1 and a device in accordance with claim 10.

By means of this it is possible to take system deviations from a defined ideal geometry into account in order to increase accuracy during firing when calculating the control values for the gun carriage servos.

Other advantageous embodiments of the invention ensue for the further dependent claims.

The invention will be explained in greater detail by way of example in what follows by means of the drawings.

### BRIEF DESCRIPTION OF THE DRAWINGS

FIG. 1 is a schematic representation of the mutual linkage of the positions of the sensor devices and effector arrangements,

FIG. 2 shows an individual observation in the course of the precision measurement in accordance with the invention,

FIG. 3 shows the result of an individual observation in accordance with FIG. 2,

FIG. 4 is a representation explaining the coordinate system used,

FIG. 5 shows the result of the entire set of observed values, and

FIG. 6 shows the result of the values corrected in accordance with the invention.

### DETAILED DESCRIPTION

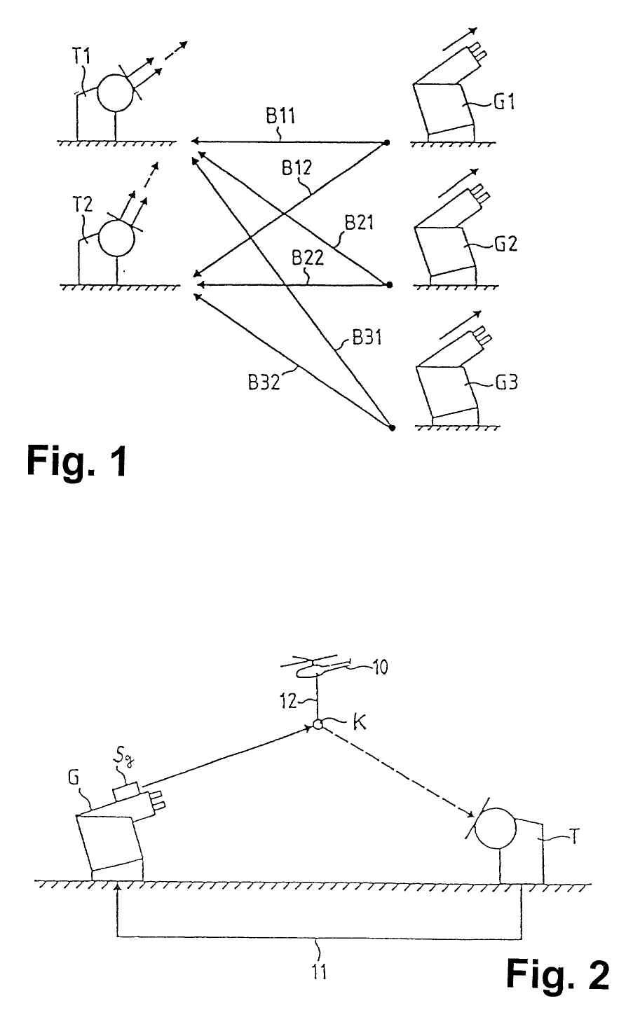

FIG. 1 shows an arrangement with a total of five devices, namely two sensor devices in the form of fire control devices T1 and T2 and three computer-controlled effector arrangements in the form of guns G1, G2, G3. The sensor devices and the effector arrangements could be located aboard ship or on land. All these arrangements T1, T2, G1, G2, G3 are placed in gun carriages or emplacements and are at least mechanically roughly aligned.

For example, a helicopter 10 and a single mounting arrangement with a sensor device T and an effector arrangement G are represented in FIG. 2. The sensor device T can be, for example, a fire control or aiming device, also identified by T, for controlling the gun G. The gun G can be provided with a TV sensor Sg, for example. The fire control device T controls the gun G via data or signal lines 11. The gun G, as well as the aiming device T, are aimed at a common measurement target K, for example a sphere also identified by K, which has been attached to a support cable 12 of the helicopter 10.

By means of this arrangement it is intended to define a correction of the aiming error vector B, or of several aiming error vectors Bⱼₖ, in FIG. 1, for example B11, B12, B21, B22, B31, B32. It is assumed here that the aiming error vector B, or the aiming error vectors Bⱼₖ, are base vectors, which are known from rough position measurements, measurements at the factory, etc. and have been stored.

A precision measurement is performed by means of the method in accordance with the invention in order to improve these known values of the aiming error vectors B, or Bⱼₖ, in several steps, or following several measurements. Therefore, after a number i of steps, the following applies to an aiming vector value B, which was corrected by a calculated correction vector Pₙ, wherein i represents whole number values from 1 to n:

B(new)=B(old)+Pₙ.

After a number n of measurements it can be assumed that Pₙ Pₛ, wherein Pₛ corresponds to the real or correct, but unattainable per se, value for the correction of the system as such.

If, for example, the sensor devices, or effector arrangements are located on a ship, in case of a change of the weight of the ship on account of its cargo, the fuel present, or a change in the shape of the ship's hull, etc., a new value for the correction value Pₛ results, which can again be approximately determined in the form of a new Pₙ value by measurements performed with the aid of the sphere K fastened to the helicopter 10. Very small changes in the shape of the hull of the ship, for example by bending or torsion, particularly following an explosion, cause a relatively large change in the reference angles. It is one aim of the invention to take these very small changes into consideration.

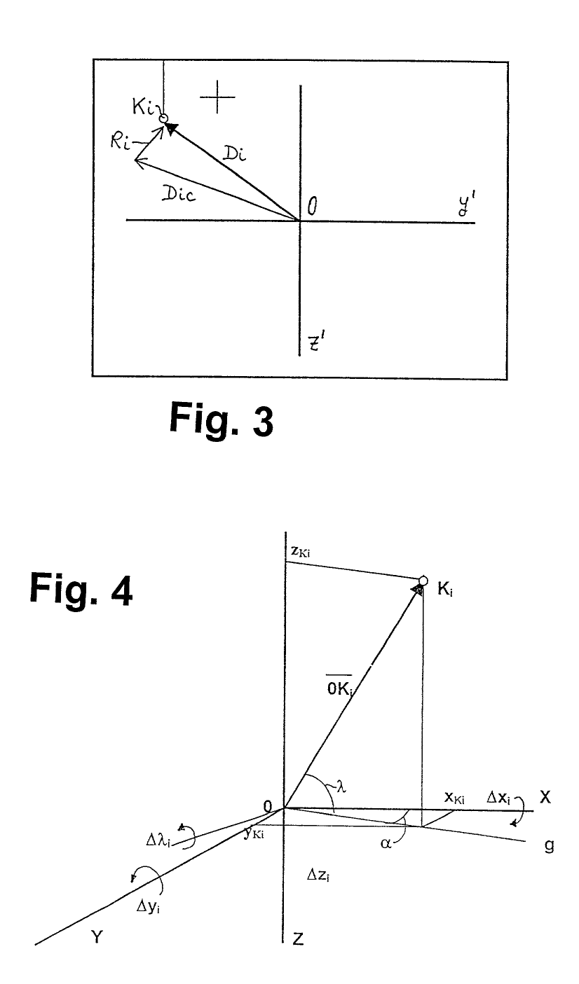

The display shown in FIG. 3 represents how the TV sensor Sg “sees” a sphere K, for example the measurement target K, or the sphere K, namely in the actual position generally with a certain amount of deviation from an intersection point O of the crosshairs of the display. This deviation, which can be directly observed by the TV sensor Sg, is a positional error, which is the result of all system errors of whatever type, such as mechanical inaccuracies as the result of manufacturing tolerances or wear, residual errors in the rough position measurements, changes in the shape of the ship's hull, measuring noise. The deviation can be considered to be an aperture vector Dᵢ with two components which, when transposed, can be represented as follows:

i Dᵢ=|dyᵢ′dzᵢ′|^{T},

wherein dyᵢ′ and dzᵢ′ are the components in the axes y′, or z′ of the aperture vector Dᵢ. The value d of the length of the aperture vector Dᵢ can be calculated in accordance with FIG. 3 as

d=(dyᵢ′²+dzᵢ′²)^{1/2.}

The display in accordance with FIG. 3 is calibrated in accordance with a predetermined distance so that the components dyᵢ′ and dzᵢ′, which actually are angles, can be represented by lengths, or distances. The following equation applies to the aperture vector Dᵢ:

Dᵢ=Mᵢ*Pₛ+Rᵢ=D_{ic}+Rᵢ, wherein Rᵢ=residual error.

Factors which affect the residual error Rᵢ are, besides the thermal noise, inter alia the motion of the sea, inaccuracies of the servo system, and the fact that the operator cannot place a mark + represented in FIG. 3 exactly on the measuring target in its instantaneous position Kᵢ.

A coordinate system in accordance with FIG. 4 is defined in the area of the aiming device T and the gun G. If, for example, the aiming device T and the gun K are located on the ground, the X-axis is oriented to the north, the Y-axis to the east and the Z-axis to the center of the earth, for example. If the aiming device T and the gun K are located on a ship, the X-axis, for example, is the longitudinal axis of the ship, the Y-axis the transverse axis, and Z-axis a right-hand axis which is orthogonal in respect to the X-axis and the Y-axis. In the coordinate system which is defined by the X-, Y-, and Z-axes, every position which the measuring target Kᵢ acan assume, is determined by three coordinates x_{K}, y_{K} and z_{K}. However, in ballistics the angle values α_{K} and λ_{K} are used as coordinates for practical reasons, wherein the azimuth angle is identified by αₖ, and the elevation angle by λₖ. Therefore the values α_{K} and λ_{K} are redundant. The coordinates x_{K}, y_{K}, z_{K} and λ_{K} are considered to be the components of a target vector OKᵢ, wherein the azimuth angle α or the elevation angle λ can also be calculated from these coordinates. The projection of the vector OK on the plane X-Y in FIG. 4 defines a straight line g, and a straight line also located in the plane X-Y and intersecting the straight line g perpendicularly in the zero point O is selected as the X-axis.

The previously mentioned recursively calculated vector Pi preferably has four components, as follows:

Pᵢ|=ΔxᵢΔyᵢΔzᵢΔλᵢ|

wherein Δxᵢ, Δyᵢ, Δzᵢ and Δλᵢ are small angle values and wherein

Δxᵢ is a rotation around the X-axis,

Δyᵢ a rotation around the Y-axis,

Δzᵢ a rotation around the Z-axis, and

Δλᵢ a rotation around the λ-axis.

These rotations or tiltings result because the plane of rotation of the effector arrangement, i.e. the gun G, is not parallel with the plane of rotation of the sensor device, i.e. the aiming device T.

The error resulting therefrom has two degrees of freedom, and therefore can be corrected by the two rotations Δxᵢ around the X-axis and Δyᵢ around the Y-axis. However, the rotation Δzᵢ around the Z-axis also includes the rotation of the azimuth Δα. Therefore a transformation matrix Mᵢ exists for each position of a target defined by a target vector OKᵢ, or for each process step i, which is defined as follows:

$${M}_{i} = \vert \begin{matrix}- cos {α}_{i} sin {λ}_{i} & - sin {α}_{i} & sin {λ}_{i} - cos {λ}_{i} & 0 \\ - sin {α}_{i} & cos {α}_{i} & 0 & 1\end{matrix} \vert$$

wherein i=1, 2, 3, . . . n.

A co-variance matrix Sᵢ also exists for each process step i, as follows:

$${S}_{i} = {S}_{i - 1} - \frac{{S}_{i - 1} * {M}_{i}^{T} * {M}_{i} * {S}_{i - 1}}{( {M}_{i} * {S}_{i - 1} * {M}_{i}^{T} + I )}$$

wherein I is an uniform matrix.

Finally, an error vector E (equation error) is defined by the following equation:

Eᵢ=Dᵢ−Mᵢ*Pᵢ₋₁.

The calculation is initialized with the following values:

$${P}_{o} = {\vert \begin{matrix}0 & 0 & 0 & 0\end{matrix} \vert}^{T}$$

$$and$$

$${S}_{o} = \vert \begin{matrix}1 & 0 & 0 & 0 \\ 0 & 1 & 0 & 0 \\ 0 & 0 & 1 & 0 \\ 0 & 0 & 0 & 1\end{matrix} \vert * C$$

wherein C is a constant.

The recurrence starts with initial values Pₒ and Sₒ and with calculated values for Mᵢ and measured values of Dᵢ=|dyᵢ′ dzᵢ′|^{T} wherein i starts with 1. From this, the values of Eᵢ and Sᵢ are determined in accordance with the above noted recurrence equations, as well as subsequently Pᵢ in accordance with the following recurrence equation:

Pᵢ=Pᵢ₋₁+Si*Mᵢ^{T}*Eᵢ wherein i=1, 2, 3 . . . n.

This recursive algorithm minimizes the following quality index J(p) (performance):

J(p)=sum (i=1, 2, . . . , n) (Dᵢ−Mᵢ*Pᵢ)^{T}*(Dᵢ−Mᵢ*Pᵢ)

The algorithm in accordance with the present invention is based on a special application of the method of the least error squares, wherein the “most advantageous” values are obtained in that the sum of squares of the respective difference between the observed value for Dᵢ and the calculated value for D_{ic}≈Mᵢ*Pₙ results in a minimum.

The calculated correction vector Pᵢ is transformed into the vector Dᵢ, or the components Δxᵢ, Δyᵢ, Δzᵢ and Δλᵢ into the components dyᵢ′, dzᵢ′, by means of the transformation matrix Mᵢ. A matrix S is used in order to avoid ambiguities in the plane of observation (FIG. 3). The matrix S is the above indicated co-variance matrix which, in particular for orthogonal-symmetrically laid out measurements, leads to a diagonal-symmetrical matrix with vanishing values in the diagonal, i.e. the track Sp or the convergence number tends toward 0. Tests in regard to the point position of this convergence number have shown that it is advantageous to select the value 49.25 or 492.5, etc. for the constant C. At C=49.25, the value of the track of the co-variance matrix Sₙ decreases from 99.99 . . . at the start to approximately 0.03 with a sufficiently large number n of measurements, or steps. However, the constant C can also be 1, or have any arbitrary value. After a number n of measurements, or recurrence steps, for example 25<n<400, preferably n . 200, the value of Pₙ tends toward the searched-for value Pₛ.

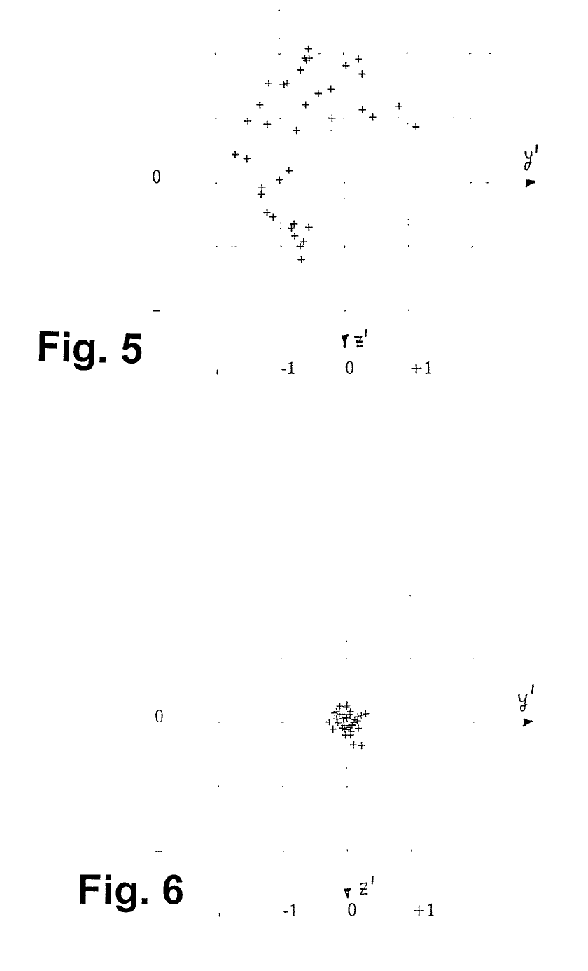

FIG. 5 shows by means of a cross + a number of actual positions of the measurement target K carried by the helicopter 10. The correspondingly corrected values of these positions are represented in FIG. 6. If the X-Y-Z coordinate system is based on a ship, the helicopter 10 preferably flies on a circular track with a radius of an order of magnitude of 1.5 km, but helically, or with increasing elevation α_{Ti}, λ_{Ti}, Δ_{Ti} around the ship. On the basis of the data determined by the aiming device T, and taking into consideration parameters so far known, in particular parallaxes between the aiming device T and the gun G, the sensor aiming line O of the gun G (instead of the line of fire, or the weapon tube axis, offset at a small parallax, of the gun G) is aimed as best as possible at a target Kᵢ, preferably automatically. The intersection point of the crosshairs of the aiming line of the sensor (Sg) (FIG. 3) points in the direction in which the measurement target Kᵢ is expected.

Therefore every point in FIG. 5 identified by a cross + respectively relates to a measured value of α_{Ki} or λ_{Ki}, i.e. to the azimuth angle or the elevation angle of the gun G, which correspond to the respective position Kᵢ of the target K carried by the helicopter 10. In contrast thereto, FIG. 6 corresponds to the theoretical values of α or λ, which, following the corrections in accordance with the present method, would be measured under exactly the same conditions, if such a further measurement would be practically possible at all. In actuality, it is impossible to repeat the measurements with the helicopter 10 in exactly the same positions as during previous measurements, and under the same ship conditions, etc.

Theoretically, due to the correction made, all points + should coincide with the zero point in FIG. 6. However, because of the residual errors Rᵢ in the system, as represented in FIG. 6, which are unavoidable, the points + do not coincide with the zero point 0, i.e. statistically diverging deviations from the zero point 0 result, whose distribution, however, is free of average values, i.e. the mean value of the divergences of the points is zero on both axes.

In comparison with other algorithms operating with different passages for computers of similar systems, the algorithm in accordance with the present invention has been shown to be particularly advantageous in view of the fact that initialization in accordance with the invention is completely problem-free, and that singularities (determinant=0) never occur, so that no “derailing” of the system needs to be feared. Such “derailments” could occur, for example, if an attempt is made in each passage to match measured values to a predetermined curve, such as a sine curve.

As in the system in accordance with patent document EP 0 314 721 B1, the correction data based on measurements, with which the aiming error vectors are corrected, have an effect which corrects the wrong aiming in real time. The measurements can again be performed from time to time, for example after four or six weeks, in order to match the correction data to changing conditions, for example those of a ship. This means that the measurement values gained from time to time can be integrated into the system and are therefore inherent in the system and therefore respectively correspond to an error which cannot be directly observed.

The sensor device T (tracker) can be a sensor, an aiming device, a radar, laser or infrared device, etc., or several such devices can be combined. Not only conventional guns, such as cannons, for example, are used as effector devices G (guns), but also rocket-firing devices or laser guns. The measurements can be performed for different G/T pairs B11, B12, B21, B22, . . . (see FIG. 1), wherein one sensor device T can also control several effector devices G.

The installation described by means of the drawings can have the required controls, computer means, or hardware, and programs, or software, in order to make possible the various methods, or partial methods, in accordance with the claimed variants, or in any arbitrary combination thereof.

What is claimed is:

1. A method for correcting aiming errors between a sensor device and an effector device (controlled by the sensor device via a servo device, by means of a correction of an aiming error vector,
characterized by
the following method steps:
a) aiming the sensor device on a measuring target,
b) aiming a target measuring sensor provided in the effector device on this measuring target, which therefore constitutes a common measuring target for the sensor device and the effector device,
c) detecting a deviation value between the position of the aiming line of the target measuring sensor, such as results from the effector device controlled by the sensor device, and the position of the measuring target as detected by the target measuring sensor,
d) employment of an existing aiming error vector as the input signal of the control, and
e) performing a subsequent recursive correction of the aiming error vector on the basis of the deviation value in accordance with the method of the least error squares.

2. The method in accordance with claim 1, characterized in that
for correcting an aiming error vector, a vector is obtained, which was recursively calculated in method steps i=1, . . . to i=n, which has at least two components, or coordinates of the deviation value for each measured position of the measuring target, and
the correction of a calculated vector is performed by multiplying an initial value or a previously calculated value with a transformation matrix, which causes a transformation of the coordinates of the measuring target as a function of the azimuth angle and the elevation angle of the target measuring sensor.

3. The method in accordance with claim 1 or 2,
characterized in that
the transformation matrix is defined as follows:
$${M}_{i} = \vert \begin{matrix}- cos {α}_{i} sin {λ}_{i} & - sin {α}_{i} & sin {λ}_{i} - cos {λ}_{i} & 0 \\ - sin {α}_{i} & cos {α}_{i} & 0 & 1\end{matrix} \vert$$
wherein i=1, 2, 3, . . . n.

4. The method in accordance with claim 2 or 3,
characterized in that
for each process step i a co-variance matrix (Sᵢ) is also used as follows:
$${S}_{i} = {S}_{i - 1} - \frac{{S}_{i - 1} * {M}_{i}^{T} * {M}_{i} * {S}_{i - 1}}{( {M}_{i} * {S}_{i - 1} * {M}_{i}^{T} + I )}$$
wherein I is a uniform matrix, an initial value of Sₒ is used for the initialization, and i=1, 2, 3 . . . n.

5. The method in accordance with one of claims 2 to 4,
characterized in that
an error vector is obtained in accordance with the following recurrence equation:
Eᵢ=Dᵢ−Mᵢ*Pᵢ₋₁
wherein Dᵢ=|dyᵢ′ dzᵢ′| is a vector with the components of the deviation values (d).

6. The method in accordance with claim 5,
characterized in that
the recurrent method steps start with freely selectable values Pₒ and Sₒ, with calculated values for Mᵢ and measured values of Dᵢ=|dyᵢ′ dzᵢ′|^{t} starting with i=1, and that from this the error value (Eᵢ) is derived in accordance with the said recurrence equation
Eᵢ=Dᵢ−Mᵢ*Pᵢ₋₁, and
the correction vector in accordance with the following recurrence equation:
Pᵢ=Pᵢ₋₁+Si*Mᵢ^{T}*Eᵢ wherein i=1, 2, 3 . . . n.

7. The method in accordance with one of claims 2 to 5,
characterized in that
the correction vector is formed by means of at least two of the following four components Δxᵢ, Δyᵢ, Δzᵢ and Δλᵢ.

8. The method in accordance with one of claims 3 to 7,
characterized in that
the calculation is performed with the correction vector Pᵢ=|Δxᵢ, Δyᵢ, Δzᵢ and Δλᵢ| and is initialized with the following values:
$${P}_{o} = {\vert \begin{matrix}0 & 0 & 0 & 0\end{matrix} \vert}^{T}$$
$$and$$
$${S}_{o} = \vert \begin{matrix}1 & 0 & 0 & 0 \\ 0 & 1 & 0 & 0 \\ 0 & 0 & 1 & 0 \\ 0 & 0 & 0 & 1\end{matrix} \vert * C$$
wherein C is a constant, which preferable has the value of 49.25.

9. The method in accordance with one of claims 1 to 8,
characterized in that
the common measuring target is guided on preselected tracks in space, preferably by means of a helicopter.

10. A device for correcting aiming errors between a sensor device and an effector device controlled by the sensor device via a servo device, by means of a correction of an aiming error vector,
wherein
the sensor device is embodied to be aimed at a measuring target,
a target measuring sensor is provided in the effector device, which is embodied to be aimed at this measuring target, which can therefore constitute a common measuring target for the sensor device and the effector device,
display means are provided for detecting a deviation value between the position of the aiming line of the target measuring sensor, such as results from the effector device controlled by the sensor device, and the position of the measuring target as detected by the target measuring sensor, and
computer means are provided in order to obtain an input signal for the servo control from an existing aiming error vector, and
to subsequently perform a correction of the aiming error vector on the basis of the deviation value in accordance with the method of the least error squares.
